(19) United States
(12) Patent Application Publication
(10) Pub. No.: US 2013/0097644 A1
(43) Pub. Date: Apr. 18, 2013

(54) Generation and Consumption of Discrete Segments of Digital Media

(71) Applicant: UAB Research Foundation, Birmingham, AL (US)

(72) Inventors: Scott Brande, Vestavia Hills, AL (US); Kursat Arslan, Ankara (TR)

(73) Assignee: UAB Research Foundation, Birmingham, AL (US)

(21) Appl. No.: 13/651,156

(22) Filed: Oct. 12, 2012

Related U.S. Application Data
(60) Provisional application No. 61/546,849, filed on Oct. 13, 2011.

(51) Int. Cl. H04N 21/25

(52) U.S. Cl. 725/93

(57) ABSTRACT

Provided are systems and methods of accessing a portion of a media file on a remote server. The method can comprise receiving a first uniform resource identifier associated with the media file; generating a first boundary point and a second boundary point associated with the portion of the media file, each of the first and second boundary points corresponding to a point in time between the beginning and ending points in time of the media file; generating a second uniform resource identifier configured to locate the portion of the media file between the first and the second boundary points; requesting from the remote server at least a part of the media file associated with the first uniform resource identifier; receiving at least the part of the media file from the remote server; and rendering the media file starting at the first boundary point and ending at the second boundary point.

### CROSS REFERENCE TO RELATED PATENT APPLICATION

This application claims priority to U.S. Provisional Application No. 61/546,849 filed Oct. 13, 2011, herein incorporated by reference in entirety.

### BACKGROUND

Digital video (DV) is a medium that can be used in activities of instruction, entertainment, business, etc. In education, for example, digital video can be employed by teachers in the classroom during teaching and by students outside of the classroom for review, study, and homework activities. In business, digital video can be used for advertising, training and presentations. Many web companies can provide free storage for the upload and viewing of digital video (e.g., YouTube, SchoolTube, TeacherTube, SciVee, etc.). User-uploaded video can be produced for many different audiences and purposes.

A number of barriers can prevent the use during classroom lectures of digital video from websites. For example, the production (creation and editing) of digital video can involve specialized programs, technical expertise, and significant amounts of labor (with associated costs). Additionally, the particular portion of digital video files of direct interest at a particular point in a lecture or presentation can be a short segment found anywhere in a longer production, not necessarily at its beginning. Web video players can begin playing files at the beginning, causing the client to scroll through the file to find the beginning of the segment of interest. Finding the right segment of a media file can not only can take time but can involve tedious adjustment of a slider to the exact point at which the desired segment begins. These and other difficulties can slow down searching for the desired beginning and stopping points of interest. Thus, there is a need for more sophisticated methods and systems for accessing digital content.

### SUMMARY

It is to be understood that both the following general description and the following detailed description are exemplary and explanatory only and are not restrictive, as claimed. Provided are systems and methods of accessing a portion of a media file on a remote server. In one aspect, the media file can have associated beginning and ending points in time.

In one aspect, exemplary methods can comprise receiving a first uniform resource identifier associated with the media file. The method can also comprise generating a first boundary point and a second boundary point associated with the portion of the media file. Each of the first and second boundary points can correspond to a point in time between the beginning and ending points in time of the media file. The method can comprise generating a second uniform resource identifier configured to locate the portion of the media file between the first and the second boundary points. The method can comprise requesting from the remote server at least a part of the media file associated with the first uniform resource identifier. The method can further comprise receiving at least the part of the media file from the remote server. The method can also comprise rendering the media file starting at the first boundary point and ending at the second boundary point.

In another aspect, exemplary devices and systems can comprise a memory having encoded thereon computer-executable instructions and data. The devices and systems can also comprise a processor functionally coupled to the memory and configured, by the computer-executable instructions, to perform at least the following actions: receiving a first uniform resource identifier associated with the media file; generating a first boundary point and a second boundary point associated with the portion of the media file, each of the first and second boundary points can correspond to a point in time between the beginning and ending points in time of the media file; generating a second uniform resource identifier configured to locate that portion of the media file between the first and the second boundary points; requesting from the remote server at least a part of the media file associated with the first uniform resource identifier; receiving at least the part of the media file from the remote server; and rendering the media file starting at the first boundary point and ending at the second boundary point.

Additional advantages will be set forth in part in the description which follows or may be learned by practice. The advantages will be realized and attained by means of the elements and combinations particularly pointed out in the appended claims.

### BRIEF DESCRIPTION OF TILE DRAWINGS

The accompanying drawings, which are incorporated in and constitute a part of this specification, illustrate embodiments and together with the description, serve to explain the principles of the methods and systems:

FIG. 1 is a block diagram illustrating an exemplary system for organizing media content;

FIG. 2 illustrates an exemplary embodiment of a system that operates in accordance with aspects of the present systems and methods;

FIG. 3 is a diagram illustrating an exemplary user interface for identifying a media segment;

FIG. 4 is a diagram illustrating an exemplary user interface for associating data with a media segment;

FIG. 5 is a diagram illustrating an exemplary user interface for obtaining a uniform resource identifier associated with a media segment;

FIG. 6 is a diagram illustrating an exemplary user interface for viewing a media segment;

FIG. 7 is a diagram illustrating an exemplary user interface for viewing a media segment;

FIG. 8 is a flowchart of an exemplary method of accessing a portion of a media file on a remote server; and

FIG. 9 is an exemplary computer system in which the present methods and systems can operate.

### DETAILED DESCRIPTION

The subject disclosure may be understood more readily by reference to the following detailed description of exemplary embodiments of the subject disclosure and to the Figures and their previous and following description.

Before the present compounds, compositions, articles, devices, and/or methods are disclosed and described, it is to be understood that the subject disclosure is not limited to specific systems and methods for management and recovery of a monetary instrument, such as a gift card. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

In the subject specification and in the claims which follow, reference may be made to a number of terms which shall be defined to have the following meanings: “Optional” or “optionally” means that the subsequently described event or circumstance may or may not occur, and that the description includes instances where said event or circumstance occurs and instances where it does not.

As employed in this specification and annexed drawings, the terms “unit,” “component,” “interface,” “system,” “platform,” and the like are intended to include a computer-related entity or an entity related to an operational apparatus with one or more specific functionalities, wherein the computer-related entity or the entity related to the operational apparatus can be either hardware, a combination of hardware and software, software, or software in execution. One or more of such entities are also referred to as “functional elements.” As an example, a unit may be, but is not limited to being, a process running on a processor, a processor, an object, an executable computer program, a thread of execution, a program, a memory (e.g., a hard disc drive), and/or a computer. As another example, a unit can be an apparatus with specific functionality provided by mechanical parts operated by electric or electronic circuitry which is operated by a software or a firmware application executed by a processor, wherein the processor can be internal or external to the apparatus and executes at least a part of the software or firmware application. In addition or in the alternative, a unit can provide specific functionality based on physical structure or specific arrangement of hardware elements. As yet another example, a unit can be an apparatus that provides specific functionality through electronic functional elements without mechanical parts, the electronic functional elements can include a processor therein to execute software or firmware that provides at least in part the functionality of the electronic functional elements. An illustration of such apparatus can be control circuitry, such as a programmable logic controller. The foregoing example and related illustrations are but a few examples and are not intended to be limiting. Moreover, while such illustrations are presented for a unit, the foregoing examples also apply to a component, a system, a platform, and the like. It is noted that in certain embodiments, or in connection with certain aspects or features thereof, the terms “unit,” “component,” “system,” “interface,” “platform” can be utilized interchangeably.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Reference will now be made in detail to the various embodiment(s), aspects, and features of the subject disclosure, example(s) of which are illustrated in the accompanying drawings. Wherever possible, the same reference numbers are used throughout the drawings to refer to the same or like parts.

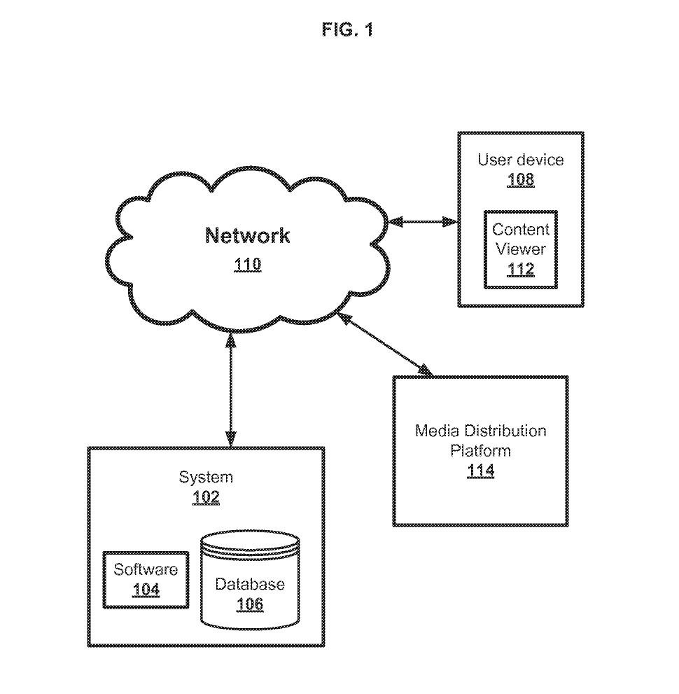

FIG. 1. is a block diagram illustrating an exemplary system 102 for organizing media content. In one aspect the system 102 can comprise software 104 configured to perform a variety of functions. For example, the software 104 can be configured to begin playing a digital media file stored on a media distribution platform 114 at an arbitrary point established by the client and to end playing the file at another arbitrary point established by the client. In one aspect, the system 102 can create a uniform resource identifier (URI) that can be used to play from a local server (e.g. the system 102) the media segment within a browser or other web application program during a live web connection. The system 102 can be configured for client access, search, browse, preview, and publication.

In one aspect, the system 102 can comprise a database 106 configured for storing information associated with one or more media segments. The database 106 can be hosted on the same computing system as the software or on a separate computing system. The system 102 can be configured to communicate with an end user using a user device 108 connected to the network 110. The user device 108 can comprise a content viewer 112 such as a web browser. The system 102 can also be configured to communicate to a media distribution platform 114. The media distribution platform 114 can be a third party distribution platform, a platform associated with the end user, or a platform associated with the system 102. The system 102 can also comprise technology for creating personal media segment libraries and contributing the media segments to the database 106. In one aspect, the database 106 can be configured as a publicly available database to enable collaboration. The system 102 can comprise server-side components (e.g., computer programs) that manage a number of functions. These functions can comprise one or more of the following: registration of user with username and password for creating a private account on the local server; playing a video from a media distribution platform 114, and using a slider bar or input box to specify the beginning (in) and ending (out) points of interest chosen by the client; creating a single link that references the media segment after identification of the particular media segment of interest; storing the link in a database 106, along with a variety of attributes, including but not limited to description and keywords, for later search and retrieval; entering information about the media segment, including categories, keywords, comments, viewing status (public/private), contributor email address, etc.; displaying image icons of all media segments in the user account, both public and private, in a filmstrip-like display; searching the database 106 by keyword and other properties (e.g., play length, contributor, date, comments, viewing status, and the like) for media segments of interest; browsing a layout of image icons that represent ail the media segments in a collection; previewing the media segments with controls for volume and screen size adjustment, and the viewing of comments and other information about the media segment to determine whether or not the media segment is of interest; sharing the media segments with colleagues or friends through the public library; and managing keywords (e.g., video, collaboration, education, business, and the like).

In one aspect, the system 102 can receive a first uniform resource identifier (e.g. a web browser compatible link). Next, the system 102 can generate a second URI that encodes information configured for playing a segment of a digital media file from a media distribution platform 114 chosen by the client. This second URI can be copied and used alone in a standard web browser to call and play the associated media segment. The second URI can be copied and inserted as a hyperlink into PowerPoint to be called during a presentation. In another aspect, the system 102 can comprise a local server that can maintain a database 106 that provides a client device the ability to build a personal digital library of media segments, with search, retrieval, and collaboration capabilities. A user of the system 102 can choose to make URIs to media segments stored in the 108 database public in order to collaborate and share media segments with other users.

In one aspect, the system 102 can provide the ability to segment a media file from a media distribution platform 114 into user-specified portions of arbitrary length without the user programming a single line of code. The ability to create different media segments from a single digital video file means that the value of a single digital video file can be enhanced with value added beyond the work as a whole in proportion to the number of segments and the different audiences that would benefit from seeing particular portions of an entire work.

In another aspect, the system 102 can comprise, or be functionally coupled to, a relational database 106 and a user interface can permit building and maintaining a database 106 of media segments. The creation of media segments can make possible the re-use of portions of an entire work within different contexts and at different times from the original video production. Examples that can benefit from the re-use of media segments of entire works include, but are not limited to, teachers in educational settings, businesses that advertise products, give multiple and similar presentations, training exercises, and the like.

In one aspect, the system 102 can transmit the second URI to the user device 108 in scripting language such as JavaScript. Furthermore, the second URI can be encrypted to increase security and decrease the risk of the use of user-generated media segments by anyone other than the user. The encryption process can be performed as follows. When the server 102 receives the second URI, the server can decode the second URI. For example, reference to the original media asset (e.g., media asset stored on YouTube) can be encrypted in the Javascript or other script at the user device. An example second URI can be the following: http://ezsnips.com/v?v=GpiKogJu6HTkb. The code part of the second URI that references the original media asset the portion of the second URI above that follows the “v?v=”, e.g., GpiKogJu6HTkb) can then be processed by ASP or other server side script on the system 102 and can be decoded to the first URI of the original media file on media distribution platform 114. For example, if the first URI links to a YouTube file, the original Youtube URI could be as follows: https://www.youtube.com/watch?v=YoA5BX7-fbs. In one aspect, the first URI, can contain the sequence “YoA5BX7-fbs”, which is not the same character sequence as the encrypted sequence “GpiKogJu6HTkb” in the second URI that can identify the media segment.

In one aspect, the second URI can be encrypted as follows sequence (the “seed”) of an arbitrary number of characters (e.g., lower and upper case letters selected from the English alphabet, printable symbols, etc.) can be generated in a random sequence and stored in the system as a constant. For each of the characters in the first URI, a character can be selected at random from the seed. After each character in the first URI is converted to one of the randomly chosen characters of the seed, this new sequence can then be substituted for the unencrypted URL. The second URI can then be generated with the encrypted sequence, and the second URI can be stored in the database 106 with other metadata about the original media asset entry.

In another aspect, the system 102 can comprise an authentication system by which the second URI can be validated by the user device 108 at the time the media segment is to be played. For example, each request by a user to view a media segment can be accompanied by an authorizing token supplied by the user device 108. With a valid token, a user request can be checked against the database 106 of current account users and approved. Additionally, the system 102 can reject the playing of any media segment that has not been previously authorized. Thus, a user device 108 can be prevented from viewing the media segment.

In one aspect, the second URI can be inserted into presentation software (or any web browser or web-compatible program), such as PowerPoint, that will play the specified digital video clip. In another aspect, the system 102 can permit the user (e.g., a client device) to access a particular segment within an entire media file with a minimum of complexity and time. In another aspect, the system 102 can expand the media from a media distribution platform 114 into a vastly larger one according to the number of ways media can be segmented for purposes that may not have been intended or foreseen by the digital media producer. In another aspect, the system 102 can provide a mechanism (e.g., a process executed in a computing device) for storing information about the particular digital video clips to facilitate search and retrieval from a private or public account. In yet another aspect, the system 102 can provide a mechanism (e.g., a process executed in a computing device) for sharing information about the media segments with others (e.g., a collaboration) who may have similar interests.

In one aspect, the system 102 eon perform the following process when a user attempts to view the media segment. First, a user can access the second URI with a content viewer 112. Access can occur by a user clicking on, for example, an image icon in the filmstrip library, or clicking in a PowerPoint file, entering the second URI in the address bar of a web browser, or similar method. Next, the system 102 can generate Javascript or other similar script that can be sent to the user device 108, The script can then cause a content player to open on the user device 112. Next, the system 102 can send commands to the media distribution platform 114 to begin streaming the media file to the player on the user device 112, beginning at the first boundary point of the media file. For some media distribution platforms 114, the first boundary point can be accessed through an API command that can control the playing of a media file on the media distribution platforms 114. Next, the system 102 can monitor the streaming process by reading the playing time streamed from media distribution platform 114. Then, the system 102 can end the streaming process when the time that corresponds to the second boundary point or end point previously associated with the media segment is reached.

In another aspect, the system 102 can receive and store votes for each media segment. For example, a user can indicate that the user “likes” the media segment. In another aspect, the system 102 can be configured to analyze the integrity of the database 106. Analzying the integrity of the database 106 can comprise checking each first URI received from the user. For example, the media file on which the media segment is based can be moved from its original location. Accordingly, the second URI, which is based on the first URI can no longer be used to locate the media segment. Thus, the system 102 can generate an error or other indicator communicating to the user that the media segment cannot currently be accessed through the system 102. Additionally, this analyzing process can be performed by the system 102 according to a predefined time schedule.

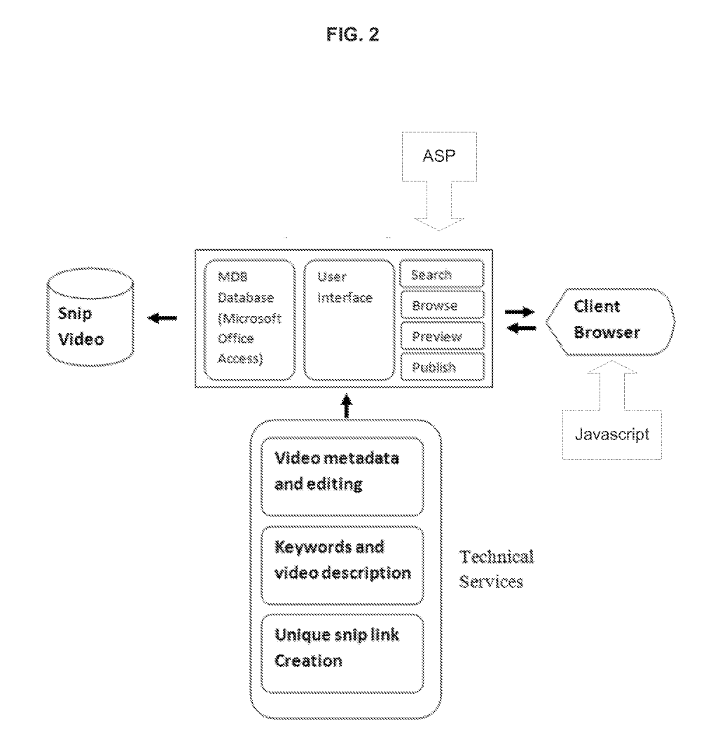

FIG. 2 illustrates an exemplary embodiment of a system that can operate in accordance with aspects of the present systems and methods. User devices (e.g., client devices) of the computing platform can connect through a web browser client to a local server. ASP (Active Server Page) or other scripting language can be used for server side scripting in order to create dynamic and interactive web pages. JavaScript or other scripting language can be used to provide enhanced user interfaces and to create the dynamic web site. In one aspect, the system can use a. Microsoft Office Access or other database to store the metadata information associated with media segments, and to provide users various services for searching, browsing, and publishing. In one exemplary implementation, the initial structure of the database of the computing platform can comprise one table with a group of attributes, such as a structure including four tables and 30 attributes with all primary keys.

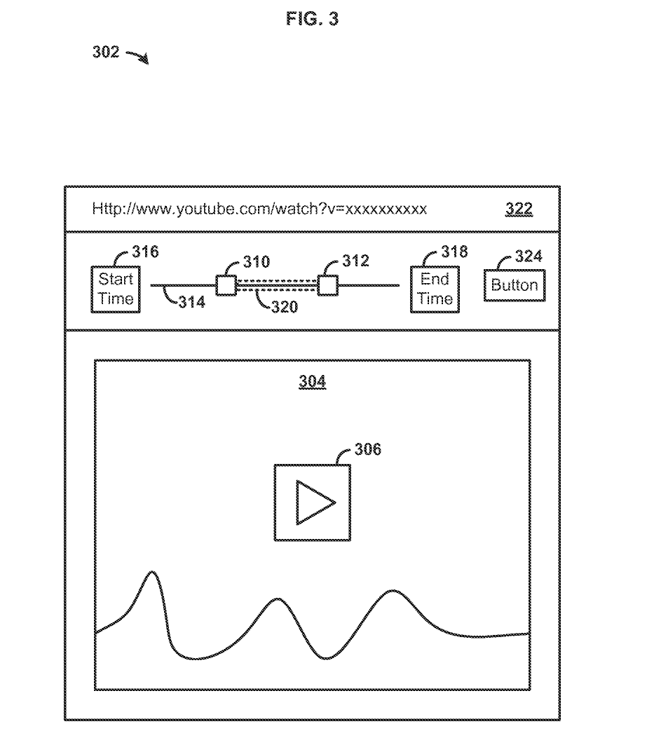

FIG. 3 is a diagram illustrating an exemplary user interface 302 for identifying a media segment. In one aspect, the user interface 302 can comprise a content player 304. The content player 304 can comprise content and one or more buttons 306 to control the content. For example, content player 304 can comprise a. play button 306. In another aspect, the user interface 302 can comprise one or more sliders 310 and 312 configured to identify a boundary of the content. For example, the user interface 302 can comprise a first slider 310 to indicate a beginning point and a second slider 312 to indicate an endpoint. The sliders 310 and 312 can be configured to move along a time line 314. In one aspect, a user can move the sliders 310 and 312 to locate one or more boundary points. The user interface 302 can comprise one or more time indicators 316 and 318. For example, the user interface 302 can comprise a start time indicator 316 and an end time indicator 318. Each time indicator 316 and 318 can correspond to a slider 310 or 312. In one aspect, a start time indicator 316 can display the time indicated by the first slider 310 on the time line 314, and an end time indicator 318 can display the time indicated by the second slider 312 on the time line 314. The user interface 302 can comprise a second time line 320 between the first slider 310 and the second slider 312. The second timeline 320 can overlay the first time line 314. For example, the second time line 320 can be a high-light between the two sliders 310 and 312.

In another aspect, the user interface 302 comprises an address box 322 configured to receive an address identifying content. The content player 304 can be hidden until an address is provided by a user in the address box. Thus, after the user provides the address, the content player 304 can appear with the content identified by the address. The user interface 302 can also comprise a submit button 324 configured to submit information identifying the boundary points provided the user. For example, the submit button 324 can send one or more time codes corresponding to the sliders 310 and 312. The submit button 324 can also submit other information such as the address provided by the user and any metadata associated with the content.

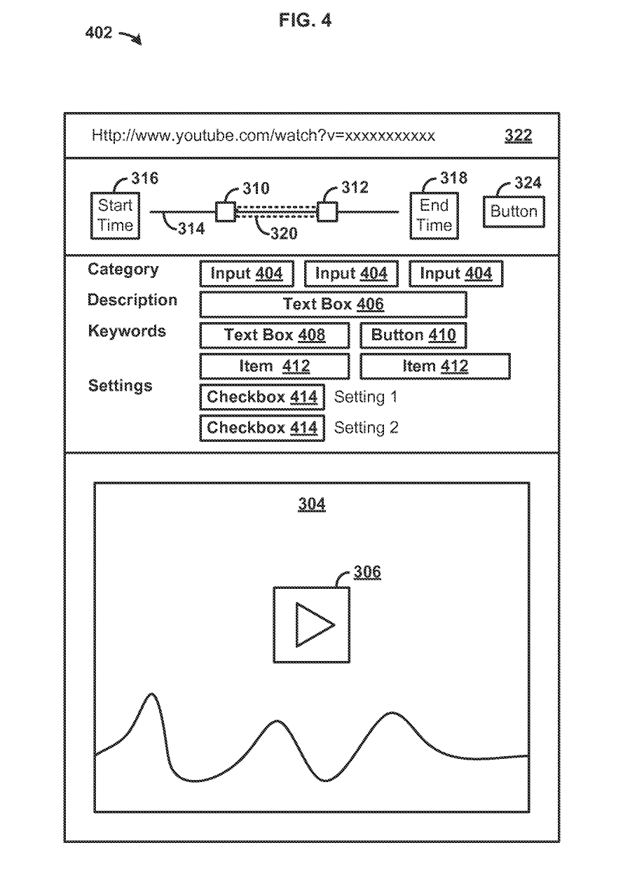

FIG. 4 is a diagram illustrating an exemplary user interface 402 for associating data with a media segment. In one aspect, the user interface 402 can comprise a section for entering data associated the media segment. For example, the user interface 402 can comprise one or more input boxes 404 for entering categories. In one aspect, the input boxes 404 for entering categories can comprise one or more drop down menus having a selectable list of categories. For example, the categories can be hierarchical in nature such that selection of a one category on a first drop down menu populates subcategories into a second drop down menu. The user interface 402 can also comprise an input box 406 for receiving a description. The input box 406 for receiving the description can, for example, comprise a text box. In one aspect, the user interface 402 can comprise an input box 408 for receiving keywords. For example, the user interface 402 can comprise a text box associated with a button 410, and when the button 410 is pressed, a keyword can appear as one or more items 412 on the user interface 402. The user interface 402 can also comprise one or input boxes 414 for receiving settings. In one aspect, the input boxes 414 for receiving settings comprise one or more check boxes, each associated with a setting listed on the user interface.

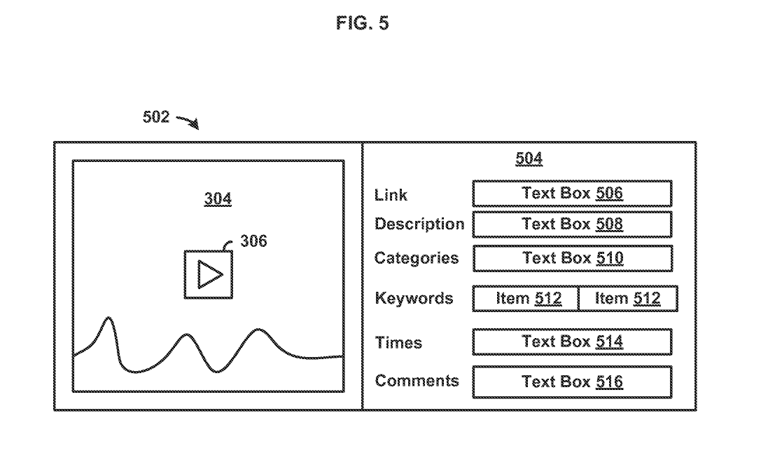

FIG. 5 is a diagram illustrating an exemplary user interface 502 for obtaining a uniform resource identifier (URI) associated with a media segment. In one aspect, the user interface 502 can comprise a section 504 for viewing data associated with the media segment. The section for viewing data associated with a media segment can comprise one or more text boxes 506, 508, 510, 512, 514, 516 and each text box can be associated with a certain type of data. For example, the section for viewing data can comprise a description, categories, keywords, a box for entering and/or viewing comments, and the like. The section for viewing data can also comprise a uniform resource identifier such as an HTML link configured to locate the media segment through a local server. The section for viewing data can also comprise time information associated with the media segment such as a beginning time, end time, duration time and the like of the media segment.

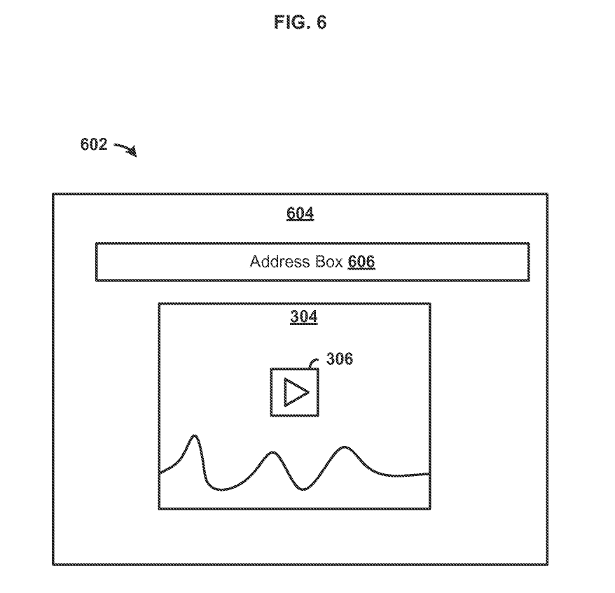

FIG. 6 is a diagram illustrating an exemplary user interface 602 for viewing a media segment. In one aspect, the media segment can be viewed in a web browser 604 directed to a uniform resource identifier. For example, the uniform resource identifier can be entered into the web browser address box 606. Instead of being a URI associated directly to a remote server where the original media file is located (e.g., the first URI), the uniform resource identifier can comprise a link to a local server (e.g., the second URI), such as the system 102 of FIG. 1. The link on the local server can be configured to locate the media segment of the media file. For example, the link on the local server can point to a content player 304 configured to start playing the media file at a first boundary point of the media file and end playing the media file at a second boundary point of the media file. The first boundary point and the second boundary point can be points in time located between the beginning and ending points of the media file.

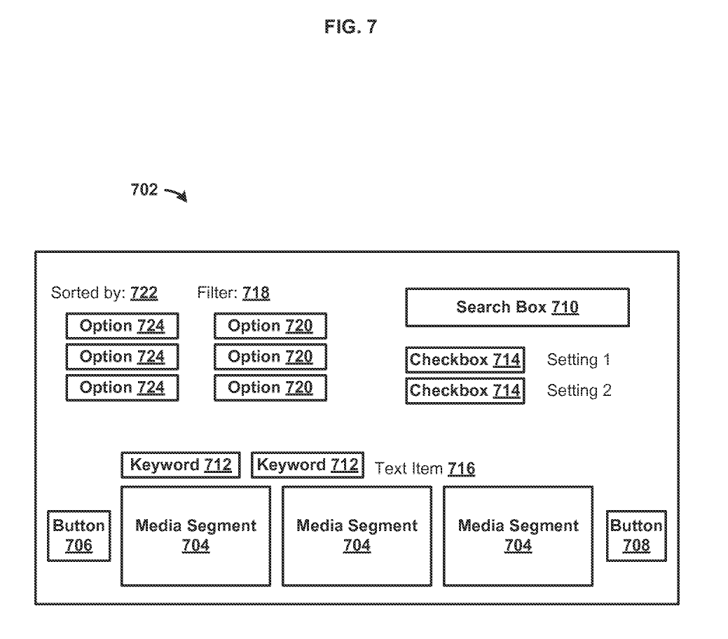

FIG. 7 is a diagram illustrating an exemplary user interface 702 for viewing a media segment. In one aspect, the user interface 702 can comprise one or more representations of media segments 704. For example, the representations of media segments 704 can each be a thumbnail image generated from the media file of which the media segment is a part. The user interface 702 can comprise one or more buttons 706 and 708 be configured to provide a browsing capability of the representations of media segments. Pressing the buttons 706 or 708 can cause a thumbnail image to scroll out of view on one side of a row of thumbnail images and cause a new thumbnail image to scroll into view on the other side of the row of thumbnail images. In another aspect, the user interface 702 can comprise a search box 710 configured to receive a search term. After receiving a search term, the representations of media segments 704 can be updated to show representations of media segments 704 associated with the search term. The user interface 702 can provide one or more keywords 712 above the representation of media segments, and the keywords 712 can indicate what search terms were received to generate the representation of media segments 704. Additionally, one or more settings for the search can be selected by one or more check boxes 714. A text item 716 can be provided for indicating information about the representation of media segments, for example, a number of media segments retrieved by a search.

In another aspect, the user interface 702 can comprise a filter section 718, The filter section 718 can comprise one or more filter options 720. Clicking on a filter option 720 can generate a new selection of representations of media segments 704. For example, the search results can be filtered by a date such as today, this week, this month, this year, or older received media segments. The user interface 702 can also comprise a sorting section 722. The sorting section can comprise one or more sorting options 724 configured to generate a new selection of representations of media segments 704 based on the option 724. For example, the search results can be sorted according to rating a date the media segment was received into the system, a view count, and the like.

In one aspect, a user can login into the user interface 702. The user interface 704 can then provide a custom selection of media segments as the one or more representations of media segments 704. In another aspect, the user interface 702 can indicate one or more active areas by darkening the user interface in areas not currently accessed by the user.

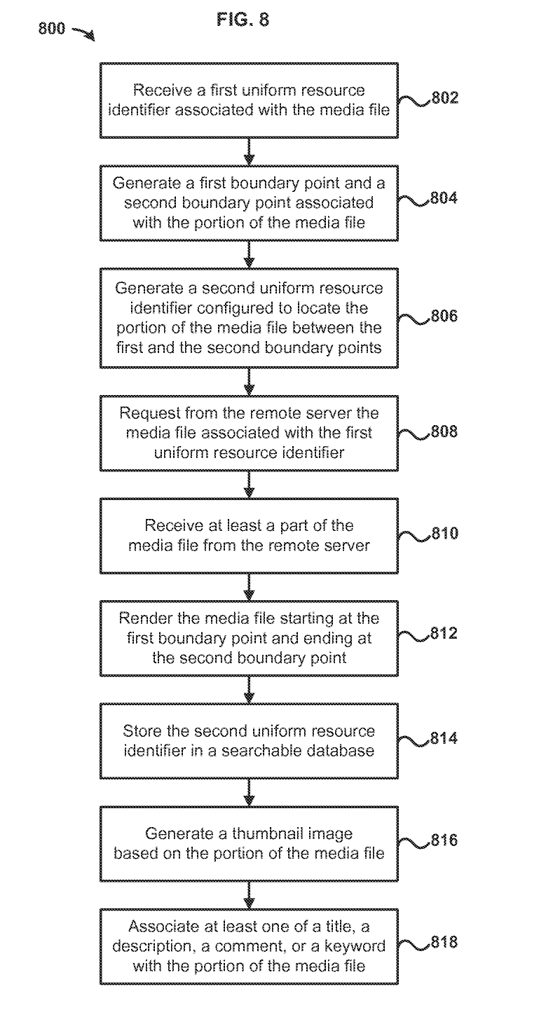

FIG. 8 is a flowchart of an exemplary method 800 of accessing a portion of a media file on a remote server. The media file can comprise associated beginning and ending points in time. In one aspect the media file is a video. For example, the media file can comprise a YouTube video or other video on a third party media distribution platform. In step 802, a first uniform resource identifier associated with the media file can be received. In step 804, a first boundary point and a second boundary point associated with the portion of the media file can be generated. Each of the first and second boundary points can correspond to a point in time between the beginning and ending points in time of the media file. In one aspect, step 804 can comprise providing a user interface configured to associate the first boundary point and the second boundary point with the portion of the media file. In another aspect, step 804 can comprise receiving the first boundary point and the second boundary point.

In step 806, a second uniform resource identifier configured to locate the portion of the media file between the first and the second boundary points can be generated. In one aspect, the first uniform resource identifier comprises a first Hypertext Markup Language (HTML) link and the second uniform resource identifier comprises a second HTML link. The second uniform resource identifier can locate a file on a local server, and the local server can be located at a different network address than the remote server. In another aspect, the local server can be located at the same network address as the remote server. Additionally, step 806 can comprise encrypting at least apart of the first uniform resource identifier.

In step 808, at least a part of the media file associated with the first uniform resource identifier can be requested from the remote server. In step 810, at least a part of the media file can be received from the remote server. In step 812, the media file can be rendered starting at the first boundary point and ending at the second boundary point. In step 814, the second uniform resource identifier can be stored in a searchable database. In step 816, a thumbnail image can be generated based on the portion of the media file. In one aspect, generating the thumbnail image comprises extracting a frame from the media file. In step 818, at least one of a title, a description, a comment, or a keyword can be associated with the portion of the media file.

In one aspect, an end user can be located at the point of delivery of the video stream output from the set-top box (data processing device) and attached TV (viewing device). Although some newer digital TVs are equipped with Internet-accessible electronics (through which output of the conventional solution may presumably be played), the present system does not require, and is not limited to, a system that requires a “set-top” box, or TV for the display output from the set-top box. Rather, in the present system, each end user can be associated with any location with hardware that is Internet-accessible with a web browser computer program (e.g., not only digital televisions, but also desktop, laptop, and tablet computers, smart phones, among other devices).

In one aspect, the processing of information in the video stream encoded with markers and tags by the content provider can be accomplished in a set-top box at the location of the end user. In another aspect, the processing of information previously stored by the content provider can be accomplished by software residing on a local server.

The present system can be used on a video stream, including those with or without such encoded markers or tags. For example, markers and tags can he generated by the content provider or markers for the beginning and/or end points can be generated by the user. Tags to describe the selected video segments can also be generated by the user.

In the present system, an end-user device can be configured to segment and then view any arbitrary segment of a video stream (or any digital media stream). The present system can be an interactive system, with one set of tags generated by the original uploader of content (content provider), with the capability of supplementing that information by other end users who may add tags to the description of the video asset.

In another aspect, a media file may be used repeatedly by the same or multiple users, each marking and tagging the same original content, in order to segment the content in different ways. In the present system, the database and associated user interface functions can provide for the lookup and retrieval of metadata specified as “public” by the multiple users of our system who have common interests. The present system can be configured for a community-based interactive system. These capabilities can permit the communication and collaboration among a community of content consumers and content creators.

In one aspect, user actions can be received within a user interface program inside a web browser. In the user interface, the user can slide an icon from the left side along a bar that represents the length of the video content to mark the point of the beginning of the segment of interest. The user can also slide a second icon from the right end along a bar to mark the point of the end of the segment of interest, These points created by the user can result in markers that delimit the media segment of interest.

In addition, pressing a button by an end-user can generate a “TAG”. Information associated with the TAG may include many different types of information, including but not limited to the exact time of the button press, the channel name and number . . . caption text . . . URLs, etc. In one aspect, these metadata can originate with the content creator. In another aspect, metadata associated with the video asset can originate through end user action. Examples of such action comprise the setting of markers to delimit the video segment of interest (e.g., timing marks), the manual input of the video URL into the user interface, the input of user-created keywords that describe the video or associated media segments of interest (keywords), and the like.

in one aspect, processing can occur at a local server. Information sent from the local server can be embedded within a web page, and displayed within a web browser on the user's Internet connected device, such as a desktop, laptop, tablet computer, smartphone, and the like.

In one aspect, a thumbnail image can be created that serves as a graphical representation of the stored video asset. For example, a frame can be extracted from the beginning of the video stream.

in one aspect, the user interface can comprise a custom arrangement of icons in tabular form (e.g., 10 per row, with three rows displayed at a time, and an arrow that permits the user to move backwards and forwards through the library of image icons). In the present system, the user can control whether or not data describing the user's use of the system is stored by marking this information as public or private.

In the present system, data describing the user's use of the system can be associated with and stored in a user account database. The system can be configured to utilize accounts according to different business modes. For example, the services of the system can be provided based on a fee depending on the particular use.

In one aspect, the database and associated user interface functions provide for the lookup and retrieval of metadata by the multiple users of our system. These capabilities allow the communication and collaboration among the community of content consumers and content creators.

In one aspect, audio streams can be processed, wherein a bookmarking function can enable an end-user to tag any points within a song to mark the beginning and end of an arbitrarily specified segment of a song.

In another aspect, the system can provide a user interface for the selection of beginning point of a media segment. The present system can permit the client device to select starting and ending points by way of input of numerical time with accuracy to the second, or by using a slider bar which can be easily adjusted to the desired point.

In one aspect, the system can be configured for selection of an ending point of the media segment. Selection of an ending point can permit a user device to control the point at which the media segment will stop playing within a media file. In one aspect, the present system can be used to select smaller segments of longer videos for presentations at time-limited meetings without video re-editing. For example, links can be inserted into PowerPoint presentations (or used simply as a browser bookmark) for playing the media segment. In one aspect, a digital video library of media segments can be compiled for multiple future re-use during different functions, such as sales training and meetings.

In one aspect, the present system can be used to build a personal library of media segments pertinent to classroom teaching, and these media segments can be shared through a public or private database of media segments. In another aspect, the system can receive comments and ratings on media segments so as to enable collaboration among users.

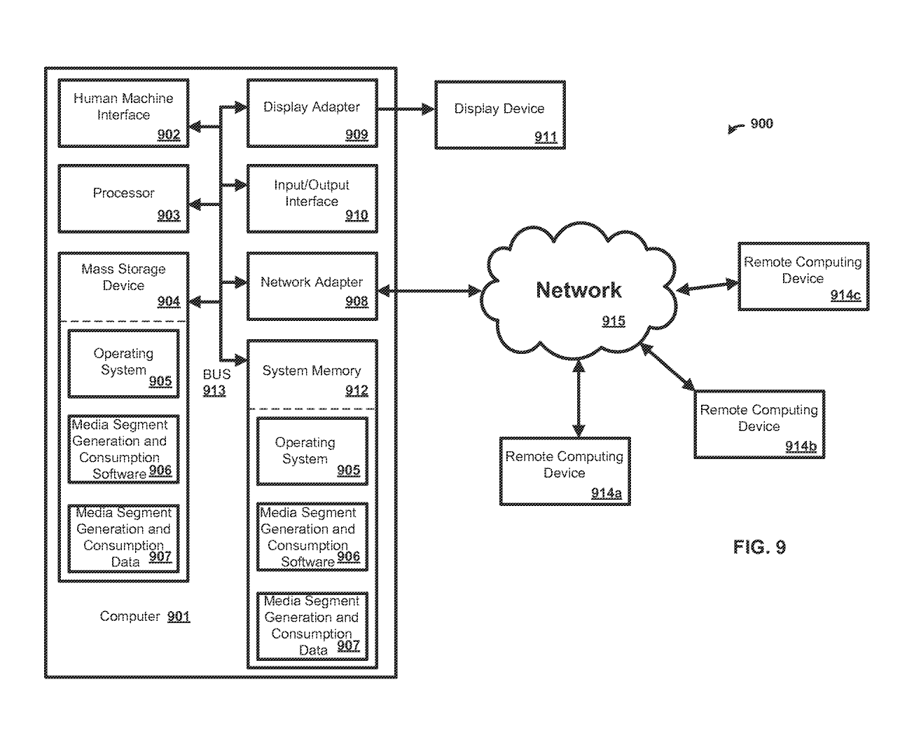

FIG. 9 illustrates a block diagram of an exemplary operating environment 900 that enables various features of the present systems and performance of the various methods disclosed herein. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The various embodiments of the present systems and methods can be operational with numerous other general purpose or special purpose computing system environments or configurations. Examples of well-known computing systems, environments, and/or configurations that can be suitable for use with the systems and methods comprise, but are not limited to, personal computers, server computers, laptop devices or handheld devices, and multiprocessor systems. Additional examples comprise wearable devices, mobile devices, set top boxes, programmable consumer electronics, network PCs, minicomputers, mainframe computers, distributed computing environments that comprise any of the above systems or devices, and the like.

The processing effected in the disclosed systems and methods can be performed by software components. The disclosed systems and methods can be described in the general context of computer-executable instructions, such as program modules, being executed by one or more computers or other computing devices. Generally, program modules comprise computer code, routines, programs, objects, components, data structures, etc., that perform particular tasks or implement particular abstract data types. The disclosed methods also can be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 901. In one scenario, the computing device 901 and functional elements therein, and/or functionally coupled thereto, can embody the system 102 of FIG. 1. The components of the computing device 901 can comprise, but are not limited to, one or more processors 903, or processing units 903, a system memory 912, and a system bus 913 that couples various system components including the processor 903 to the system memory 912. In the case of multiple processing units 903, the system can utilize parallel computing.

In general, a processor 903 or a processing unit 903 refers to any computing processing unit or processing device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally or alternatively, a processor 903 or processing unit 903 can refer to an integrated circuit, an application specific integrated circuit (ASIC); a digital signal processor (DSP), a field programmable gate array (FPGA); a programmable logic controller (PLC), a complex programmable logic device (CPLD), a discrete gate or transistor logic, discrete hardware components, or any combination thereof designed to perform the functions described herein. Processors or processing units referred to herein can exploit nano-scale architectures such as; molecular and quantum-dot based transistors, switches and gates, in order to optimize space usage or enhance performance of the computing devices that can implement the various aspects of the subject disclosure. Processor 903 or processing unit 903 also can be implemented as a combination of computing processing units.

The system bus 913 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCT-Express bus, a Personal Computer Memory Card Industry Association (PCMCIA), Universal Serial Bus (USB) and the like. The bus 913, and all buses specified in this description also can be implemented over a wired or wireless network connection and each of the subsystems, including the processor 903, a mass storage device 904, an operating system 905, media segment generation and consumption software 906, media segment generation and consumption data 907, a network adapter 908, system memory 912, an Input/Output Interface 910, a display adapter 909, a display device 911, and a human machine interface 902, can be contained within one or more remote computing devices 914a,b,c at physically separate locations, connected through buses of this form, in effect implementing a fully distributed system. When executed by a processor (e.g., processor 903), the media segment generation and consumption software 906 can generate a media segment, such as a video segment, an audio segment, or the like, in accordance with aspects described herein. In addition or in the alternative, when executed by a processor, the media segment generation and consumption software 906 can permit consumption (e.g., generation and delivery of a web-based link) of a media segment. In one aspect, execution of the media segment generation and consumption software 906 can implement the technical services presented in FIG. 1, for example. The media segment generation and consumption data 907 can include the data associated with technical services in FIG. 1, for example.

The computing device 901 typically comprises a variety of computer readable media. Exemplary readable media can be any available media that is accessible by the computing device 901 and comprises, for example and not meant to be limiting, both volatile and non-volatile media, removable and non-removable media. The system memory 912 comprises computer readable media in the form of volatile memory, such as random access memory (RAM), and/or non-volatile memory, such as read only memory (ROM). The system memory 912 typically contains data (such as a group of tokens employed for code buffers) and/or program modules such as operating system 905 and media segment generation and consumption software 906 that are immediately accessible to and/or are presently operated on by the processing unit 903. Operating system 905 can comprise OSs such as Windows operating system, Unix, Linux, Symbian, Android, iOS, Chromium, and substantially any operating system for wireless computing devices or tethered computing devices.

In another aspect, the computing device 901 also can comprise other removable/non-removable, volatile/non-volatile computer storage media. By way of example, FIG. 9 illustrates a mass storage device 904 which can provide non-volatile storage of computer code, computer readable instructions, data structures, program modules, and other data for the computing device 901. For example and not meant to be limiting, a mass storage device 904 can be a hard disk, a removable magnetic disk, a removable optical disk, magnetic cassettes or other magnetic storage devices, flash memory cards, CD-ROM, digital versatile disks (DV D) or other optical storage, random access memories (RAM), read only memories (ROM), electrically erasable programmable read-only memory (EEPROM), and the like.

Optionally, any number of program modules can be stored on the mass storage device 904, including by way of example, an operating system 905, and media segment generation and consumption 906. Each of the operating system 905 and media segment generation and consumption software 906 (or some combination thereof) can comprise elements of the programming and the media segment generation and consumption software 906. Data and code (e.g., computer-executable instruction(s)) can be retained as part of media segment generation and consumption software 906 and can be stored on the mass storage device 904. Media segment generation and consumption software 906, and related data and code, can be stored in any of one or more databases. Such databases can be part of computing device 901 or can be networked with (e.g., functionally coupled to) computing device 901, such as a database. Examples of such databases comprise, DB2®, Microsoft®Access, Microsoft® SQL Server, Oracle®, mySQL, PostgreSQL, and the like. Further examples include membase databases and flat file databases. The databases can be centralized or distributed across multiple systems.

In another aspect, the user can enter commands and information into the computing device 901 via an input device (not shown). Examples of such input devices comprise, but are not limited to, a camera; a keyboard; a pointing device (e.g., a “mouse”); a microphone; a joystick; a scanner (e.g., barcode scanner); a reader device such as a radiofrequency identification (REID) readers or magnetic stripe readers; gesture-based input devices such as tactile input devices (e.g., touch screens, gloves and other body coverings or wearable devices), speech recognition devices, or natural interfaces; and the like. These and other input devices can be connected to the processing unit 903 via a human machine interface 902 that is coupled to the system bus 913, but can be connected by other interface and bus structures, such as a parallel port, game port, an IEEE 1394 Port (also known as a Firewire port), a serial port, or a universal serial bus (USB).

In yet another aspect, a display device 911 also can be connected to the system bus 913 via an interface, such as a display adapter 909. It is contemplated that the computing device 901 can have more than one display adapter 909 and the computing device 901 can have more than one display device 911. For example, a display device can be a monitor, an LCD (Liquid Crystal Display), or a projector. In addition to the display device 911, other output peripheral devices can comprise components such as speakers (not shown) and a printer (not shown) which can be connected to the computing device 901 via Input/Output Interface 910. Any step and/or result of the methods can be output in any form to an output device. Such output can be any form of visual representation, including, but not limited to, textual, graphical, animation, audio, tactile, and the like.

The computing device 901 can operate in a networked environment using logical connections to one or more remote computing devices 914a,b,c. By way of example, a remote computing device can be a personal computer, portable computer, a mobile telephone, a server, a router, a network computer, a peer device or other common network node, and so on. Logical connections between the computing device 901 and a remote computing device 914a,b,c can be made via a local area. network (LAN) and a general wide area network (WAN). Such network connections can be through a network adapter 908. A network adapter 908 can be implemented in both wired and wireless environments. Such networking environments are conventional and commonplace in offices, enterprise-wide computer networks, intranets, and one or more network(s) 915 (e.g., the Internet). Networking environments generally can be embodied in wireline networks or wireless networks (e.g., cellular networks, such as Third Generation (3G) and Fourth Generation (4G) cellular networks, facility-based networks (femtocell, picocell, Wi-Fi networks, etc.).

As an illustration, application programs and other executable program components such as the operating system 905 are illustrated herein as discrete blocks, although it is recognized that such programs and components reside at various times in different storage components of the computing device 901, and are executed by the data processor(s) of the computer. An implementation of media segment generation and consumption software 906 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer-readable media can comprise “computer storage media,” or “computer-readable storage media,” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

As described herein, while various aspects of the subject disclosure are described in connection with generation and consumption of video segments, the computing platform described herein can permit generation and consumption of segments of digital media in general, such as audio segments, motion picture segments, and the like.

In various embodiments, the systems and methods of the subject disclosure can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

While the systems, devices, apparatuses, protocols, processes, and methods have been described in connection with exemplary embodiments and specific illustrations, it is not intended that the scope be limited to the particular embodiments set forth, as the embodiments herein are intended in all respects to be illustrative rather than restrictive. Unless otherwise expressly stated, it is in no way intended that any protocol, procedure, process, or method set forth herein be construed as requiring that its acts or steps be performed in a specific order. Accordingly, in the subject specification, where description of a process or method does not actually recite an order to be followed by its acts or steps or it is not otherwise specifically recited in the claims or descriptions of the subject disclosure that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

It will be apparent to those skilled in the art that various modifications and variations can be made in the subject disclosure without departing from the scope or spirit of the subject disclosure. Other embodiments of the subject disclosure will be apparent to those skilled in the art from consideration of the specification and practice of the subject disclosure as disclosed herein. It is intended that the specification and examples be considered as non-limiting illustrations only, with a true scope and spirit of the subject disclosure being indicated by the following claims.

What is claimed is:

1. A method of accessing a portion of a media file on a remote server, the media file having associated beginning and ending points in time, the method comprising:
receiving a first uniform resource identifier associated with the media file;
generating a first boundary point and a second boundary point associated with the portion of the media file, each of the first and second boundary points corresponding to a point in time between the beginning and ending points in time of the media file;
generating a second uniform resource identifier configured to locate the portion of the media file between the first and the second boundary points;
requesting from the remote server at least a part of the media file associated with the first uniform resource identifier;
receiving at least the part of the media file from the remote server; and
rendering the media file starting at the first boundary point and ending at the second boundary point.

2. The method of claim 1, wherein the first boundary point and the second boundary point generating step comprises receiving the first boundary point and the second boundary point.

3. The method of claim 1, wherein the first boundary point and the second boundary point generating step comprises providing a user interface configured to associate the first boundary point and the second boundary point with the portion of the media file.

4. The method of claim 1, wherein generating a second uniform resource identifier c comprises encrypting at least a part of the first uniform resource identifier.

5. The method of claim 1, wherein the media file is a YouTube video.

6. The method of claim 1, wherein the first uniform resource identifier comprises a first Hypertext Markup Language (HTML) link and the second uniform resource identifier comprises a second HTML link.

7. The method of claim 1, wherein the second uniform resource identifier locates a file on a local server, the local server is located at a different network address than the remote server.

8. The method of claim 1, further comprising storing the second uniform resource identifier in a searchable database.

9. The method of claim 1, further comprising generating a thumbnail image based on the portion of the media file.

10. The method of claim 9, wherein generating the thumbnail image comprises extracting a frame from the media file.

11. The method of claim 1, further comprising associating at least one of a title, a description, a comment, or a keyword with the portion of the media file.

12. A device for accessing a portion of a media file on a remote server, the media file having associated beginning and ending points in time, the device comprising:
a memory having encoded thereon computer-executable instructions and data; and
a processor functionally coupled to the memory and configured, by the computer-executable instructions, to perform at least the following actions,
receiving a first uniform resource identifier associated with the media file;
generating a first boundary point and a second boundary point associated with the portion of the media file, each of the first and second boundary points corresponding to a point in time between the beginning and ending points in time of the media file;
generating a second uniform resource identifier configured to locate that portion of the media file between the first and the second boundary points;
requesting from the remote server at least a part of the media file associated with the first uniform resource identifier;
receiving at least the part of the media file from the remote server; and
rendering the media file starting at the first boundary point and ending at the second boundary point.

13. The device of claim 12, wherein the first boundary point and the second boundary point generating step comprises receiving the first boundary point and the second boundary point.

14. The device of claim 12, wherein the first boundary point and the second boundary point generating step comprises providing a user interface configured to associate the first boundary point and the second boundary point with the portion of the media file.

15. The device of claim 12, wherein the media file is a video.

16. The device of claim 12, wherein the first uniform resource identifier comprises a first Hypertext Markup Language (HTML) link and the second uniform resource identifier comprises a second HTML link.

17. The device of claim 12, wherein the second uniform resource identifier locates a file on a local server, and the local server is located at a different network address than the remote server.

18. The device of claim 12, wherein the processor is further configured o store the second uniform resource identifier in a searchable database.

19. The device of claim 12, wherein the processor is further configured to generate a thumbnail image based on the portion of the media file, wherein generating the thumbnail image comprises extracting a frame from the media file.

20. The device of claim 12, wherein the processor is further configured to associate at least one of a title, a description, a comment, or a keyword with the portion of the media file.
